(19) United States
(12) Patent Application Publication
(10) Pub. No.: US 2021/0205830 A1
(43) Pub. Date: Jul. 8, 2021

(54) Integrated Pump Pressure Washer

(71) Applicant: GXi Holdings, LLC, Ft. Worth, TX (US)

(72) Inventors: Gordon W. Jackson, Ft. Worth, TX (US); Brian K. Sawyer, Clayton, NC (US)

(73) Assignee: GXi Holdings, LLC, Ft. Worth, TX (US)

(21) Appl. No.: 17/208,473

(22) Filed: Mar. 22, 2021

Related U.S. Application Data
(63) Continuation-in-part of application No. 14/951,684, filed on Nov. 25, 2015, now abandoned.
Application No. 14/951,684 is a continuation-in-part of application No. 12/748,588, filed on Mar. 29, 2010, now abandoned.
(60) Provisional application No. 61/266,214, filed on Dec. 3, 2009.

(51) Int. Cl. B05B 9/08; B08B 3/02; F02B 63/06; F04B 53/00; F04B 53/18

(52) U.S. Cl. CPC B05B 9/0855; B08B 3/026; F02B 63/06; B08B 2203/0241; F04B 53/18; B08B 2203/027; F04B 53/006

(57) ABSTRACT

An integrated pressure washer is disclosed. The integrated pressure washer has an engine. At the bottom of the engine is an engine bottom cover. The engine bottom cover has a recess formed by a cylindrical wall that extends up from a base of the engine bottom cover. The pressure washer also has a pump assembly. The pump assembly is attached to the engine bottom cover and extends into the recess. The pump assembly receives water and applies pressure to the water and directs the pressurized water out a high pressure hose.

This application is a Continuation-in-Part of U.S. Non-Provisional patent application Ser. No. 14/951,684, filed on Nov. 25, 2015, which is a Continuation-in-Part of U.S. Non-Provisional patent application Ser. No. 12/748,588, filed on Mar. 29, 2010, which claims priority of U.S. Provisional Application 61/266,214 filed on Dec. 3, 2009 and they are included herein in their entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to an engine powered pressure washer and, more specifically, to an integrated pump pressure washer.

### Description of Related Art

Pressure washers are used to clean various surfaces by projecting high pressure water. A typical pressure washer consists of an engine, a pump, a water intake, a high pressure hose, and a gun and wand assembly. Water from a garden hose is typically provided to the intake of the pump. An engine connected to the pump turns a crankshaft which drives the pump. The pump pressurizes the incoming water and the high pressure spray is directed out of the high pressure wand. The user simply squeezes the trigger on the wand to turn the high pressure spray on and off.

Pressure washers may vary in size and shape. Typically, pressure washers are designed to be portable; therefore, size may be an important factor in the pressure washer design since the size of the pressure washer may impact everything from shipping costs, to density of stocking, to consumer transportation to storage. Thus, a pressure washer that delivers the same performance, but in a smaller overall package, is desired.

One of the drawbacks related to current pressure washers is that the pumping mechanism is simply bolted on to the end of a drive shaft that protrudes out the engine. A pressure washer with a pump mounted in this manner may be bulky and contain additional parts such as castings, seals, and bearings. In the prior art, the pump may be added as an extension of the engine crankshaft. The present invention integrates the pump housing directly into the engine bottom or side cover, thus providing a pressure washer with a smaller profile. In addition, a pressure washer using the concepts of the present invention may be lighter and more efficient.

### SUMMARY OF THE INVENTION

A single piece engine bottom cover for use in an engine powered pressure washer is disclosed. The single piece engine bottom cover has a base upon which is attached a cylindrical wall. The cylindrical wall extends away from the base. The cylindrical wall creates a recess, and the recess has a bottom end. The bottom end extends into the base. The bottom end has a crankshaft opening, the crankshaft opening allows a crankshaft to protrude there through, wherein the recess is adapted to fit a pump assembly which is inserted into the recess and attached to the cylindrical wall.

An integrated pressure washer is disclosed. The integrated pressure washer has an engine, which further has an engine bottom cover. The engine bottom cover has a recess which is formed by a cylindrical wall that extends away from the engine bottom cover. The integrated pressure washer has a pump assembly. The pump assembly attaches to the engine bottom cover and extends into the recess. The pump assembly receives water and applies pressure to the water and directs the pressurized water out a high pressure outlet.

An integrated pressure washer is disclosed. The integrated pressure washer has an engine. At the bottom of the engine is an engine bottom cover. The engine bottom cover is adapted to receive a pump assembly. The pump assembly has a pump manifold and a recess, the recess is formed by a cylindrical wall that extends away from the pump manifold. The pump assembly attaches directly to the engine bottom cover and the pump assembly receives water and applies pressure to the water and directs the pressurized water out a high pressure outlet.

In one embodiment, there is a smaller size pressure washer comprising:
a) an engine comprising
   i. a crankshaft extending away from the engine; and
   ii. a base;
b) a one-piece engine bottom cover having a single recess wherein the crankshaft that extends away from the engine, terminates in the recess;
c) a pump assembly integrated entirely into the recess, attached to the crankshaft;
d) a pump manifold attached to the engine bottom cover; and
e) a single lubricating liquid sealed entirely in the recess.

### BRIEF DESCRIPTION OF THE DRAWINGS

FIG. 1 displays a power washer in accordance with one aspect of the present invention.

FIG. 2 displays a side perspective view of the engine and pump assembly of the power washer of FIG. 1.

FIG. 3 displays aside view of the engine and pump assembly of the power washer of FIG. 1.

FIG. 4 displays a bottom view of the engine with the pump assembly removed.

FIG. 5 displays a bottom engine cover in accordance with one embodiment of the present invention.

FIG. 6 displays an exploded view of the pump assembly in accordance with one embodiment of the present invention as it fits on to the engine cover shown in FIG. 5.

FIG. 7 displays a bottom engine cover in accordance with another embodiment of the present invention.

FIG. 8 displays an exploded view of the pump assembly in accordance with another embodiment of the present invention as it fits on to the engine cover shown in FIG. 7.

FIG. 9 displays a bottom engine cover in accordance with a further embodiment of the present invention.

FIG. 10 displays an exploded view of a pump assembly in accordance with a further embodiment of the present invention as it fits on to the engine cover shown in FIG. 9.

FIG. 11 displays a side view the pump assembly as it fits on to a horizontal shaft engine.

FIG. 12 displays a front view the pump assembly as it fits on to the horizontal shaft engine.

### DETAILED DESCRIPTION OF THE INVENTION

While this invention is susceptible to embodiment in many different forms, there is shown in the drawings, and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

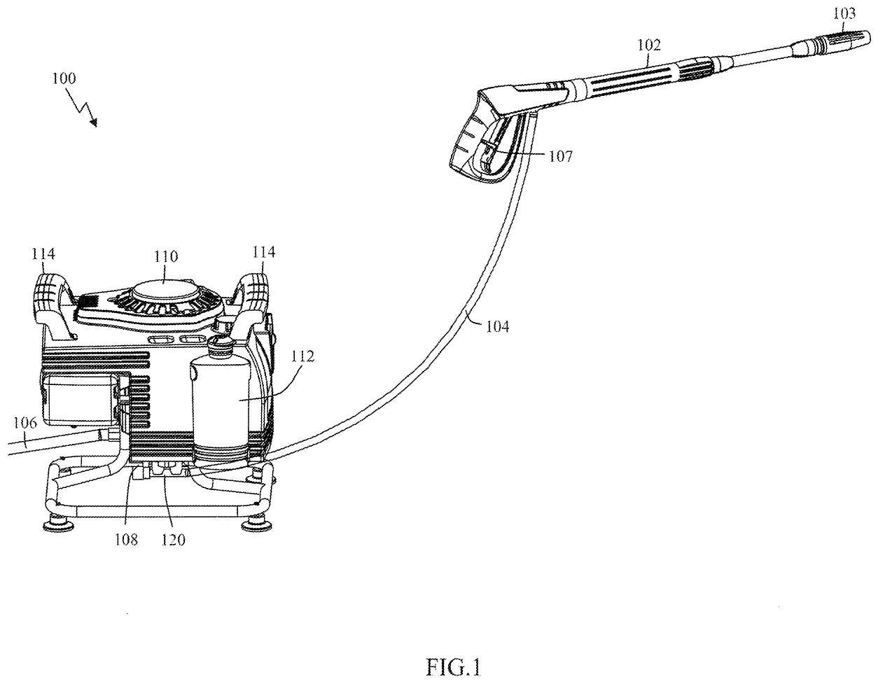

FIG. 1 shows an integrated pump and pressure washer in accordance with one embodiment of the present invention. The integrated pump and pressure washer (hereinafter referred to as pressure washer 100) consists of an engine 110, a pump assembly 120 and a gun 102 and a wand 103. The gun 102 is connected to the pump assembly 120 by a gun hose 104. At the end of the gun 102, the wand 103 directs the stream of pressurized water as it exits. In the embodiment of FIG. 1, the engine 110 is a gasoline engine with a gas tank 112 attached to the side of the engine 110. The pressure washer 100 has handles 114 which allow a user to easily grasp and move the pressure washer 100. On the pump assembly is a water intake connector 108 upon which a water hose 106 may be coupled. As depicted in FIG. 1, the engine 110 is a vertical shaft engine.

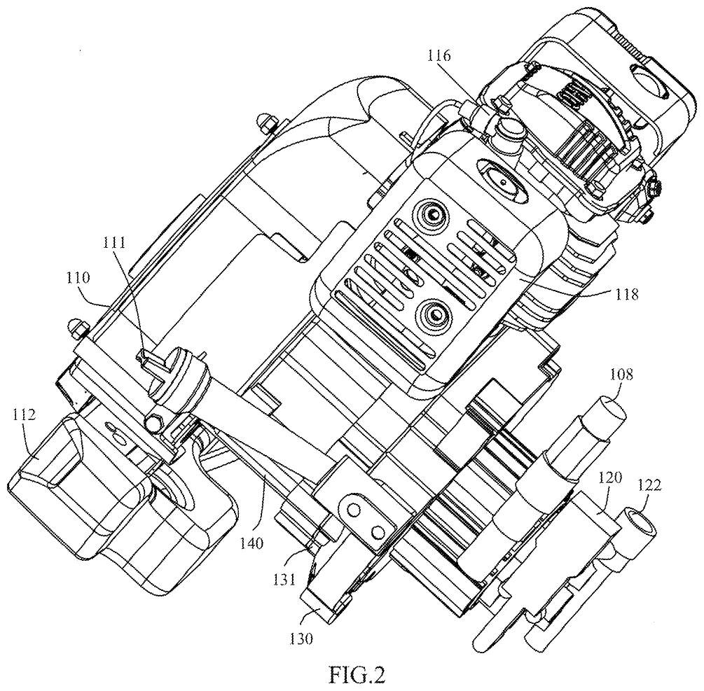

Water may be fed into the pump assembly 120 through the water hose 106. As is described in subsequent sections, when the engine 110 is running a crankshaft is being turned. The turning crankshaft causes pistons within the pump assembly 120 to develop high pressure within the pump assembly manifold. The high pressure is applied to the incoming water. The pressurized water is then directed through the high pressure connector 122 (See FIG. 2) to the gun hose 104, through the gun 102 and out the wand 103 when a trigger 107 is depressed. Although a gasoline engine is displayed in FIG. 1, other types of engines may also be used along with the inventive concepts of the present invention to produce the same results.

FIG. 2 displays aside perspective view of the engine 110 and pump assembly 120 of the pressure washer 100. As can be seen from this view, a muffler 118 and spark plug 116 are positioned on the side of the engine 110. The spark plug 116 is installed into the top of the cylinder which is part of the engine block 140. The spark plug 116 provides the spark necessary to keep the internal combustion engine running. Fuel is routed from the gas tank 112 through a carburetor and into the cylinder to be ignited by the spark plug 116. The exhaust from the internal combustion engine is then routed out of the cylinder via exhaust valves and out the muffler 118. Additionally, engine oil is splashed within the engine 110 and an oil dip stick 111 may be used to confirm the engine oil level within the engine block 140.

At the bottom of the engine block 140 is an engine bottom cover 130. Affixed to the engine bottom cover 130 is the pump assembly 120. The water intake connector 108 and the high pressure connector 122 are on the pump assembly 120. The engine bottom cover 130 may be manufactured out of cast aluminum and provides a seal to the bottom of the engine block 140. Spaced in between the engine block 140 and the engine bottom cover 130 may be a gasket 131. As can be seen in FIG. 2, the engine bottom cover 130 is integrated into the engine block 140.

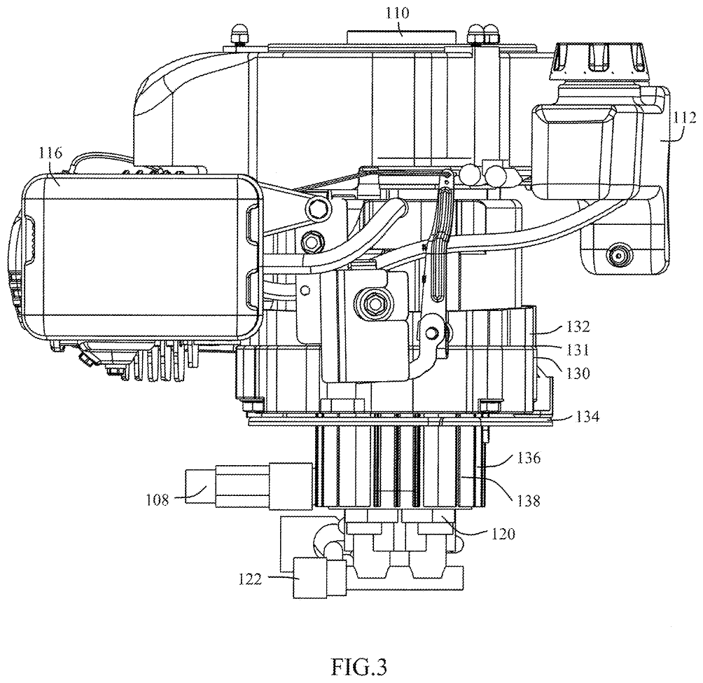

FIG. 3 displays a side view of the engine 110 and pump assembly 120. As can be seen in FIG. 3, the engine bottom cover 130 has a top edge 132 which extends away from a base 134 as well as a wall 136. In the embodiment of FIG. 3, the wall 136 is cylindrically shaped. Although the wall 136 is cylindrically shaped, in further embodiments, the wall 136 may be any shape as long as it is a continuous wall and may encapsulate the pump assembly 120. The wall 136 extends away from the base 134 and creates a recess 138, into which the pump assembly 120 extends when the pump assembly 120 is attached to the engine 110. At the bottom of the recess 138 is a crankshaft opening through which the crankshaft extends when the engine bottom cover 130 is attached to the engine 110. The recess 138 and wall 136 combined may also be referred to as a pump housing. The pump assembly 120 extends into the recess 138 when it is affixed to the engine bottom cover 130.

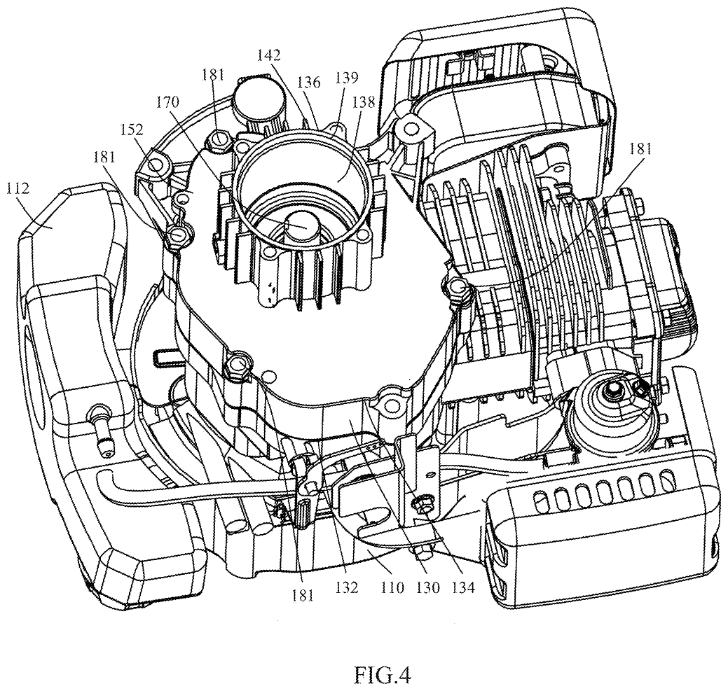

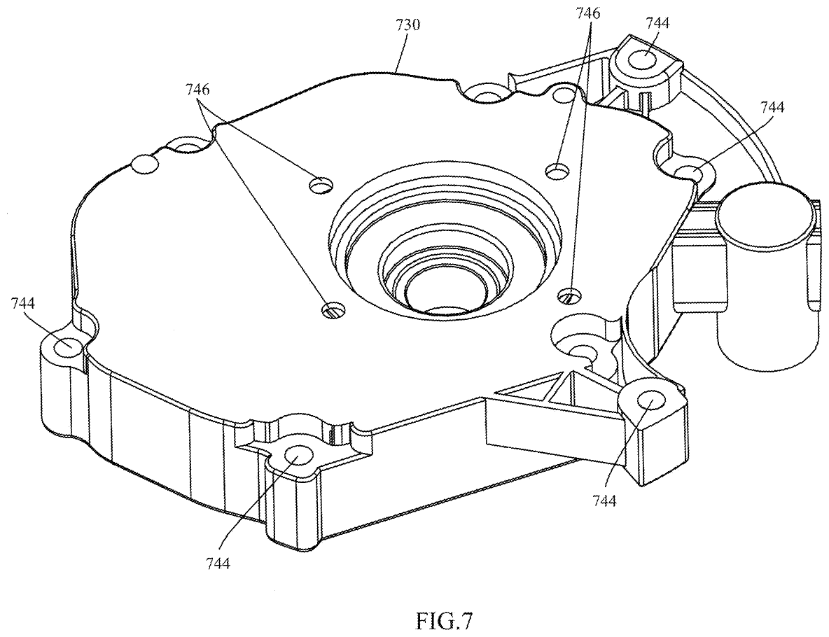

A better view of the pump housing 139 is displayed in FIG. 4. FIG. 4 is a bottom view of the engine 110 with the pump assembly 120 removed. In the embodiment as displayed in FIG. 4, the engine bottom cover 130 is attached to the bottom of the engine 110 and held in place by bolts 181. The surface of the engine bottom cover 130 may be flat or ribbed. Extending into the recess 138 is a crankshaft 170 (See also FIG. 7). As mentioned previously, the crankshaft 170 is connected to the piston of the engine and is rotated when the engine is running. In one embodiment, the crankshaft 170 may be slotted. In an alternative embodiment, the crankshaft 170 may be keyed. The crankshaft 170 may be keyed or slotted in order to mesh up with the receiving member within the pump assembly 120.

One advantage of the present invention is that the crank shaft 170 may be shorter since the pump assembly 120, when attached, is much closer to the engine than the prior art pressure washers. Utilizing an engine bottom cover 130 as shown in FIG. 4 allows the pump assembly 120 to be integrated into the bottom of the engine. Integrating the pump assembly 120 into the engine reduces the height of the overall pressure washer 100. In addition, integrating the pump assembly 120 also allows the pressure washer manufacturer to reduce the number of parts required to connect the pump assembly 120 with the engine 110. For example, one combined crankshaft/pump shaft seal may be used instead of a separate crankshaft seal and a pump shaft seal.

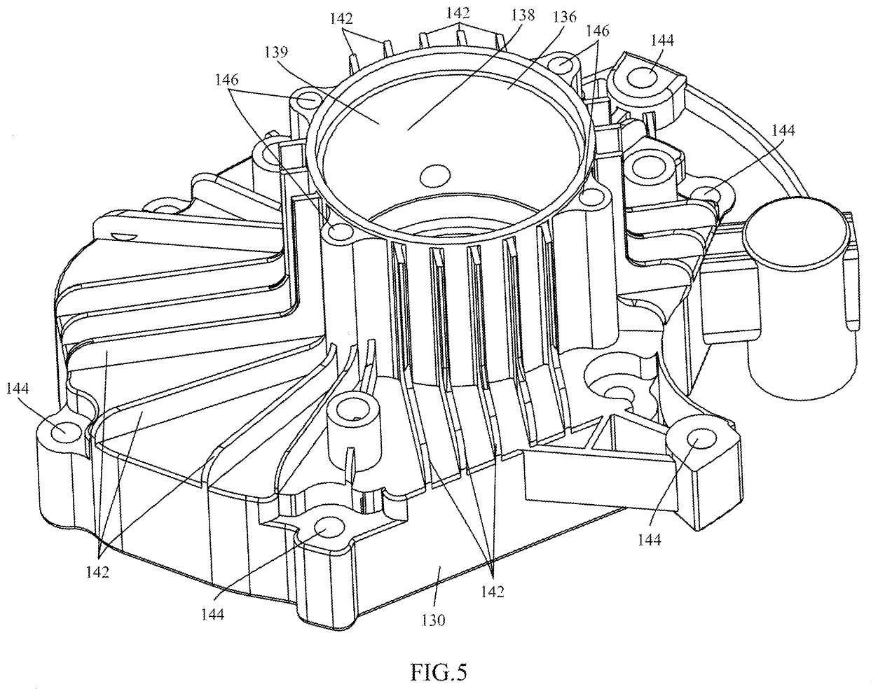

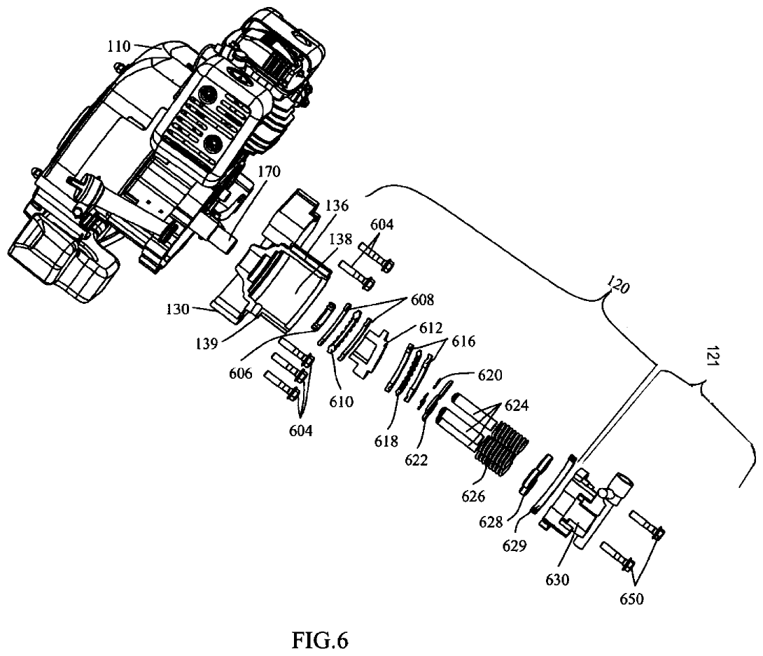

Another advantage of the present invention is that a separate casting may not be necessary. The engine bottom cover 130 as shown in FIGS. 5 and 6 may be a single casting, thus eliminating additional material that may be required for multiple castings. Another advantage of the engine bottom cover 130 having the integrated pump housing 139 is that the number of fasteners necessary to affix the engine bottom cover 130 into place may be less than an engine bottom cover not having the integrated pump housing 139.

Additionally, a pressure washer 100 employing the concepts of the present invention may only need one bearing assembly, instead of two. Some prior art pressure washers have thrust bearings and radial bearings, which may be eliminated in embodiments of the present invention. Another advantage of the present invention is that the manufacturing process may require only one step to integrate, assemble and test when building the engine. The engine manufacturer may also assemble the pump assembly 120 into the engine bottom cover 130 thus allowing the engine manufacturer to build the complete pressure washer 100.

FIG. 5 displays the engine bottom cover 130 in accordance with one embodiment of the present invention. On the engine bottom cover 130 are bolt mounting holes 144 as well as fins 142. The fins 142 may act as a heat sink and provide a means to displace some of the heat that may be generated by the engine 110 when it is running. In the embodiment of FIG. 5, the fins 142 may extend away from the walls 136 and extend to the edges of the engine bottom cover 130. Also shown on the engine bottom cover 130 are pump assembly mounting holes 146. In this embodiment, there are four pump assembly mounting holes 146. After the engine bottom cover 130 is affixed to the bottom of the engine 110, the pump assembly 120 may be attached by attaching and tightening bolts which extend through the pump assembly 120 and into the pump assembly mounting holes 146.

The engine bottom cover 130 may be constructed out of various types of metals. In one embodiment, the engine bottom cover 130 may be made of cast aluminum. Alternatively, the engine bottom cover 130 may be made of cast iron or stainless steel. Several factors may need to be taken into consideration such as, but not limited to, weight, cost, manufacturability and the like. Aluminum may be preferred due to its availability, cost and light weight nature. Regardless, the engine bottom cover 130 should be of sufficient thickness and strength to withstand the operation of the pump assembly 120 when fully assembled.

In one embodiment of the present invention, the pump assembly 120 may be an axial pump. Within any axial pump, pistons move up and down creating the pressure that is applied to the water coming in the water inlet 108. In axial piston pumps, the pistons stroke in the same direction on a cylinder block's centerline (axially). Axial piston pumps may be an in-line or angled design. Pressures generated by the pump assembly 120 may be as high as 5,000 psi. Axial pumps are usually very efficient and the pumps typically have excellent durability. Petroleum oil fluids are usually required within the pump assembly 120 to keep the moving parts lubricated.

Types of axial piston pumps may include, but are not limited to, in-line pumps, wobble plate in-line pumps and bent-axis axial pumps. In an in-line piston pump, a drive shaft and cylinder block are on the same centerline. Reciprocation of the pistons is caused by a swashplate that the pistons run against as a cylinder block rotates. In one embodiment of the present invention, the drive shaft 170 turns a cylinder block, which carries the pistons around a shaft. The piston shoes slide against a swashplate and are held against it by a shoe plate. A swashplate's angle causes the cylinders to reciprocate in their bores. At the point where a piston begins to retract, an opening in the end of a bore slides over an inlet slot in a valve plate, and oil is drawn into a bore through somewhat less than half a revolution. There is a solid area in a valve plate as a piston becomes fully retracted. As a piston begins to extend, an opening in a cylinder barrel moves over an outlet slot, and oil is forced out a pressure port.

A wobble plate pump is a variation of an in-line piston pump. In this embodiment, a cylinder barrel does not turn. Instead a wobble plate wobbles as it is turned by the crankshaft 170. The wobbling of the wobble plate pushes the pistons in and out of the pumping chambers in a stationary cylinder barrel. In a wobble-plate pump, separate inlet and outlet check valves are required for each piston, since the pistons do not move past a port.

In an angle- or a bent-axis-type piston pump, the piston rods are attached by ball joints to a drive shaft's flange. A universal link keys a cylinder block to a shaft so that they rotate together but at an offset angle. A cylinder barrel turns against a slotted valve plate to which the ports connect. Pumping action is the same as an in-line pump. The angle of offset determines a pump's displacement, just as the swash plate's angle determines an in-line pump's displacement. In fixed-delivery pumps, the angle is constant. In variable models, a yoke swings a cylinder block to vary displacement. Flow direction can be reversed with appropriate controls.

Although various types of pumps may be used in conjunction with the present invention, a wobble plate in-line axial pump is shown as the pump assembly 120 in the exploded view of FIG. 6. As mentioned previously, the crankshaft 170 extends away from the engine 110 through the recess 138 of the engine bottom cover 130 and attaches to the pump assembly 120.

As the crankshaft 170 extends into the recess 138, a crankshaft seal 606 is attached over the crankshaft 170. The crankshaft seal 606 prevents any oil or other type of lubricant that may be used from leaking out of the recess 138 by way of the crankshaft 170.

In one embodiment, the recess 138 as shown in the figures consists of a single compartment wherein the recess 138 is positioned entirely below the base 134, the crankshaft extending and terminating in recess 138. In one embodiment, there is a single lubricating liquid for both the engine and pump assembly 120 which is entirely contained within the single recess/compartment with a single crankshaft/pump shaft seal 606, i.e. no access for lubricating liquid to pass from the recess 138 to any other part of the pressure washer.

The pump assembly 120 is integrated entirely into the engine bottom cover 130, pump manifold 121 is attached to the engine bottom cover. The pump assembly mounting holes 146 are threaded and constructed to fit the bolts 604.

When the pump assembly 120 is attached to the engine bottom cover 130, the crankshaft 170 mates up with a wobble plate 612. Prior to insertion into the wobble plate 612, two lower thrust bearing races 608 and a lower thrust bearing rack 610 are placed on the crankshaft 170. The thrust bearing rack 610 may contain ball bearings to facilitate the movement of the wobble plate 612.

On the top of the wobble plate 612 is a set of upper thrust bearing races 616 and an upper thrust bearing rack 618. Spring retaining clips 620 secure spring retainers 622 into place. Pump pistons 624 extend through piston return springs 626. An oil seal 628 is attached at the bottom of the pistons 624. The oil seal 628 keeps the oil or other type of lubricant contained within the pump assembly 120 from leaking into the pump manifold 630. Pump manifold 630 attaches to the pump housing 139 of the engine bottom cover 130 and keeps the components of the pump assembly 120 in place. The pump manifold 630 is attached to the engine bottom cover by bolts 650.

As the engine 110 is running, the crankshaft 170 is turning, causing the wobble plate 612 to rotate. In turn, the rotation of the wobble plate 612 causes the pistons 624 to move in an up and down fashion. The movement of the pistons 624 causes pressure to be created and in turn applied to the water that enters the pump manifold 630 and is in turn directed out the high pressure outlet 122.

As described previously, by integrating the pump assembly 120 entirely into the bottom engine cover 130, the pressure washer 100 increases efficiency compared to the attachment of the pump assembly outside of the engine bottom cover. Bringing the components of the pump assembly closer to the engine 110 and the crankshaft 170, reduces the length of the crankshaft 170 and may increase the power transfer efficiency. Integrating the pump assembly entirely into the bottom engine cover 130 also allows the pressure washer manufacturer to manufacture a smaller sized power washer that may deliver the same if not greater pressurized fluid delivery than those where the pump assembly is attached at least partially outside of to the engine bottom cover, rather than entirely in the engine bottom cover.

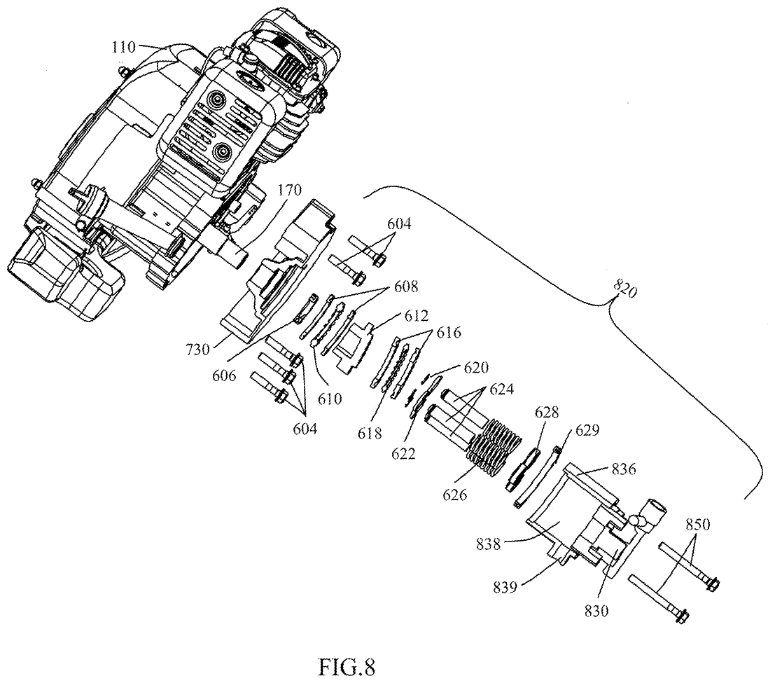

FIG. 7 displays the engine bottom cover 730 in accordance with another embodiment of the present invention. On the engine bottom cover 730 are bolt mounting holes 744. In contrast to the engine bottom cover 130 of FIG. 5, the engine bottom cover 730 does not contain walls which support the pump assembly. Instead, as can be seen in FIG. 8, pump assembly 820 has walls 836 which form the recess 838 into which the internal components of the pump assembly 820 are located. In one exemplary embodiment, the pump assembly 820 may have the same internal components as the pump assembly 120. The walls 836 of pump assembly 820 attach directly to the engine cover 730.

Referring back to FIG. 7, the engine bottom cover 730 has pump assembly mounting holes 746. In this embodiment, there are four pump assembly mounting holes 746. Now back to FIG. 8, after the engine bottom cover 730 is affixed to the bottom of the engine 110 using engine mounting holes 744, the pump assembly 820 may be attached by attaching and tightening bolts which extend through the pump assembly 820 and into the pump assembly mounting holes 746. The crankshaft 170 extends away from the engine 110 through the recess 838 of the pump assembly 820.

As the crankshaft 170 extends into the recess 838, a crankshaft seal 606 is attached over the crankshaft 170. The crankshaft seal 606 prevents any oil or other type of lubricant that may be used from leaking out of the recess 838 by way of the crankshaft 170. In alternative embodiments, the crankshaft seal 606 may be removed to allow oil or other type of lubricant to flow into the recess 838.

Bolts 604 are used to attach the pump assembly 820 to the engine bottom cover 730 and are inserted in pump manifold 839 and into pump assembly mounting holes 746. The pump assembly mounting holes 746 are threaded and constructed to fit the bolts 604.

When the pump assembly 820 is attached to the engine bottom cover 730, the crankshaft 170 mates up with a wobble plate 612. Prior to insertion into the wobble plate 612, two lower thrust bearing races 608 and a lower thrust bearing rack 610 are placed on the crankshaft 170. The thrust bearing rack 610 may contain ball bearings to facilitate the movement of the wobble plate 612.

On the top of the wobble plate 612 is a set of upper thrust bearing races 616 and an upper thrust bearing rack 618. Spring retaining clips 620 secure spring retainers 622 into place. Pump pistons 624 extend through piston return springs 626. An oil seal 628 is attached at the bottom of the pistons 624. The oil seal 628 keeps the oil or other type of lubricant contained within the pump assembly 820 and from leaking into the pump manifold 830. Pump manifold 830 attaches to the engine bottom cover 130 with bolts 850 and keeps the components of the pump assembly 820 in place.

As the engine 110 is running, the crankshaft 170 is turning, causing the wobble plate 612 to rotate. In turn, the rotation of the wobble plate 612 causes the pistons 624 to move in an up and down fashion. The movement of the pistons 624 causes pressure to be created and in turn applied to the water that enters the pump manifold 830 and is in turn directed out the high pressure outlet 122.

As described previously, by integrating the pump assembly 820 into the bottom engine cover 730, the pressure washer 100 may have increased efficiency. Bringing the components of the pump assembly closer to the engine 110 and the crankshaft 170 reduces the length of the crankshaft 170 and may increase the power transfer efficiency. Integrating the pump assembly into the engine bottom cover 730 also allows the pressure washer manufacturer to manufacture a smaller power washer that may deliver the same if not greater pressurized fluid delivery.

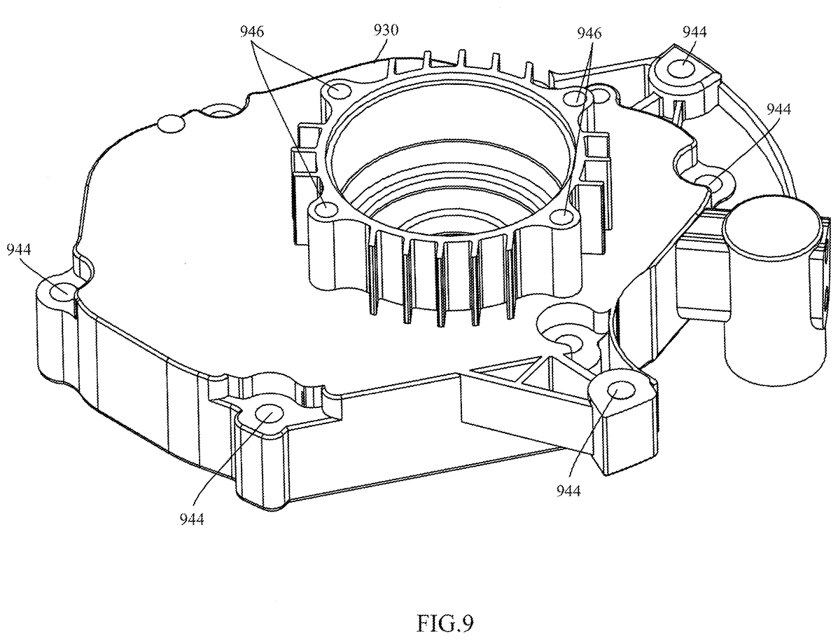

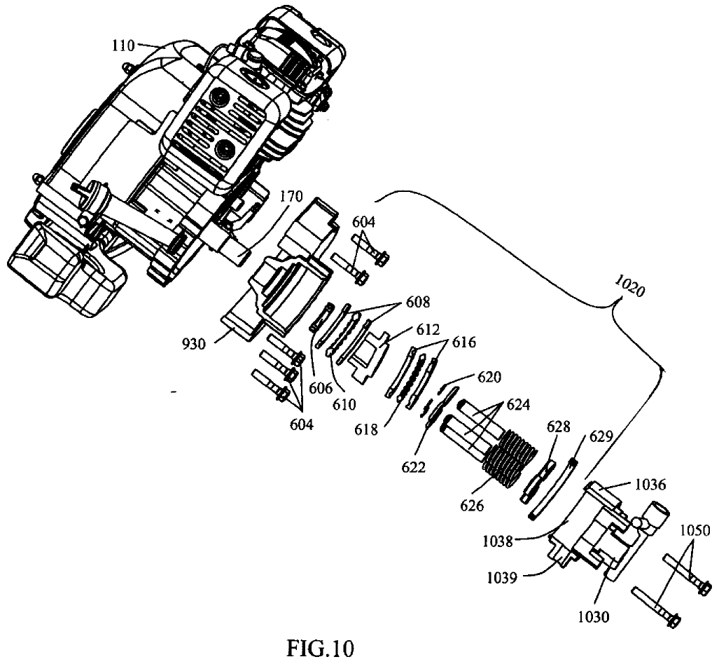

FIG. 9 displays an engine bottom cover 930 in accordance with another embodiment of the present invention. On the engine bottom cover 930 are bolt mounting holes 944. In contrast to the engine bottom cover 730 of FIG. 7 and engine bottom cover 130 of FIG. 5, the engine bottom cover 930 has a partial wall which supports the pump assembly 1020 (FIG. 10). Instead, as can be seen in FIGS. 9 and 10, pump assembly 1020 has walls 1036 which form the recess 1038 into which the internal components of the pump assembly 1020 are located. In one exemplary embodiment, the pump assembly 1020 may have the same internal components as the pump assembly 120.

Referring back to FIG. 9, the engine bottom cover 930 has pump assembly mounting holes 946. In this embodiment, there are four pump assembly mounting holes 946. After the engine bottom cover 930 is affixed to the bottom of the engine 110 using engine mounting holes 944, the pump assembly 1020 may be attached by attaching and tightening bolts which extend through the pump assembly 1020 and into the pump assembly mounting holes 946. The crankshaft 170 extends away from the engine 110 through the recess 1038 of the pump assembly 1020.

As the crankshaft 170 extends into the recess 1038, a crankshaft seal 606 is attached over the crankshaft 170. The crankshaft seal 606 prevents any oil or other type of lubricant that may be used from leaking out of the recess 1038 by way of the crankshaft 170. In alternative embodiments, the crankshaft seal 606 may be removed to allow oil or other type of lubricant to flow into the recess 1038.

Bolts 604 are used to attach the pump assembly 1020 to the engine bottom cover 930 and are inserted in pump manifold 1039 and into pump assembly mounting holes 946. The pump assembly mounting holes 946 are threaded and constructed to fit the bolts 604. Although not shown, a gasket or other type of seal may be applied on the engine bottom cover 930 to form a pressurized seal between the engine bottom cover 930 and the pump assembly 1020 when the bolts 604 are attached.

When the pump assembly 1020 is attached to the engine bottom cover 930, the crankshaft 170 mates up with a wobble plate 612. Prior to insertion into the wobble plate 612, two lower thrust bearing races 608 and a lower thrust bearing rack 610 are placed on the crankshaft 170. The thrust bearing rack 610 may contain ball bearings to facilitate the movement of the wobble plate 612.

On the top of the wobble plate 612 is a set of upper thrust bearing races 616 and an upper thrust bearing rack 618. Spring retaining clips 620 secure spring retainers 622 into place. Pump pistons 624 extend through piston return springs 626. An oil seal 628 is attached at the bottom of the pistons 624. The oil seal 628 keeps the oil or other type of lubricant contained within the pump assembly 1020 and from leaking into the pump manifold 630. Pump manifold 1030 attaches to the engine bottom cover 930 with bolts 1050 and keeps the components of the pump assembly 1020 in place.

As the engine 110 is running, the crankshaft 170 is turning, causing the wobble plate 612 to rotate. In turn, the rotation of the wobble plate 612 causes the pistons 624 to move in an up and down fashion. The movement of the pistons 624 causes pressure to be created and in turn applied to the water that enters the pump manifold 1030 and is in turn directed out the high pressure outlet 122.

As described previously, by integrating the pump assembly 1020 into the bottom engine cover 930, the pressure washer 100 may have increased efficiency. Bringing the components of the pump assembly closer to the engine 110 and the crankshaft 170 reduces the length of the crankshaft 170 and may increase the power transfer efficiency. Integrating the pump assembly into the engine bottom cover 930 also allows the pressure washer manufacturer to manufacture a smaller power washer that may deliver the same if not greater pressurized fluid delivery.

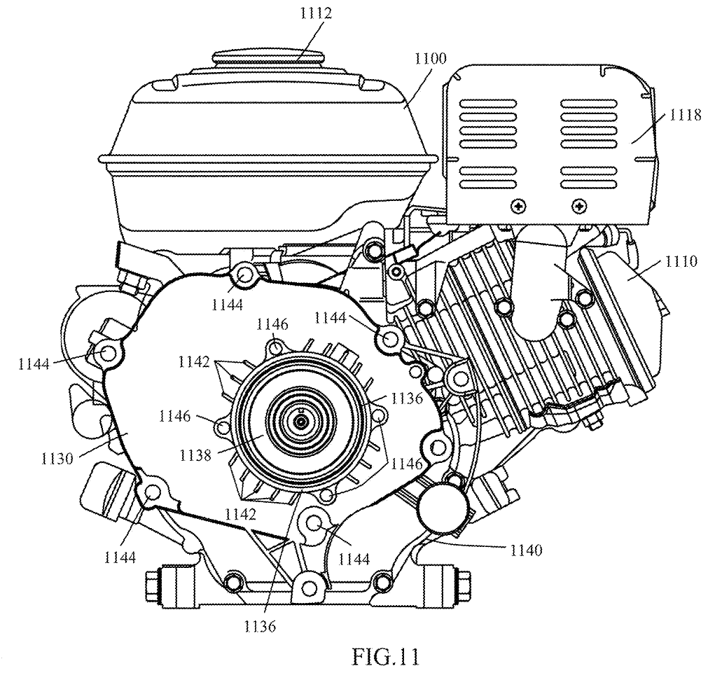

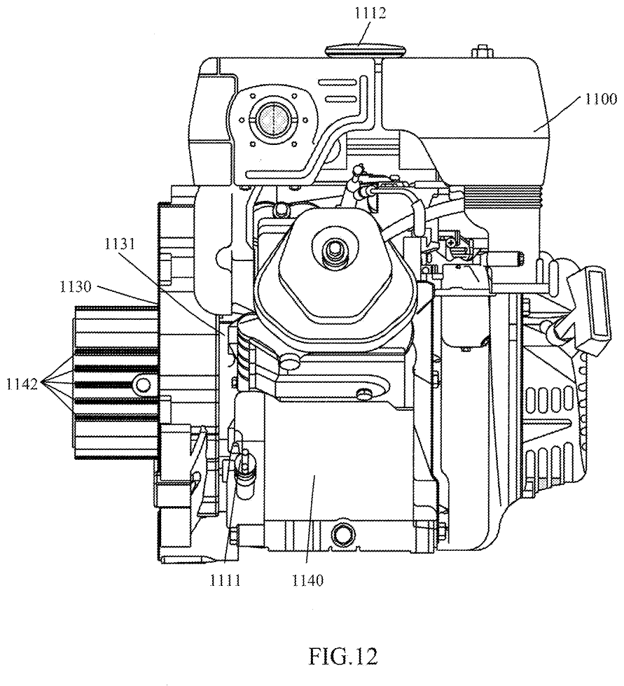

FIGS. 11 and 12 display a pressure washer 1100 having a horizontal shaft engine 1110 utilizing an engine bottom cover 1130 in accordance with another embodiment of the present invention. As shown in FIG. 11 the pump assembly of the pressure washer 1100 is removed to show the inner view of the recess 1138. Similar to the pressure washer 100 of FIG. 1, wall 1136 extends radially around the crankshaft and away from the engine bottom cover 1130.

As can be seen from this view, a muffler 1118 is positioned on the side of the engine 1110. A spark plug is installed into the top of the cylinder which is part of the engine block 1140. Fuel is routed from the gas tank 1112 through a carburetor and into the cylinder to be ignited by the spark plug. The exhaust from the internal combustion engine is then routed out of the cylinder via exhaust valves and out the muffler 1118. Additionally, engine oil is circulated within the engine 1110 and an oil dip stick 1111 may be used to confirm the engine oil level within the engine block 1140.

At the bottom of the engine block 1140 is the engine bottom cover 1130. When assembled, the pump assembly is affixed to the engine bottom cover 1130. In another exemplary embodiment, the engine bottom cover 1130 may be manufactured out of cast aluminum and provides a seal to the bottom of the engine block 1140. Spaced in between the engine block 1140 and the engine bottom cover 1130 may be a gasket 1131. The engine bottom cover 1130 may also have fins 1142 which are on the outside of wall 1136. In the embodiment of FIG. 11, the fins 1142 may be positioned on the wall 1136. In another embodiment, the fins 1142 may extend to the outer edge of the engine bottom cover 1130.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A smaller size pressure washer comprising:
a) an engine comprising
i. a crankshaft extending away from the engine; and
ii. abase;
b) a one-piece engine bottom cover having a single recess wherein the crankshaft that extends away from the engine, terminates in the recess;
c) a pump assembly integrated entirely into the recess, attached to the crankshaft;
d) a pump manifold attached to the engine bottom cover; and
e) a single lubricating liquid sealed entirely in the recess.
